(19) United States
(12) Patent Application Publication
(10) Pub. No.: US 2003/0147366 A1
(43) Pub. Date: Aug. 7, 2003

(54) Combining transport formats having heterogeneous interleaving schemes

(76) Inventor: Benoist Sebire, Espoo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/062,669

(22) Filed: Feb. 5, 2002

(51) Int. Cl. H04J 3/00

(52) U.S. Cl. 370/337; 370/338; 370/347; 370/349

(57) ABSTRACT

In a mobile communication system employing heterogeneous interleaving schemes, rate matching is employed to reduce the radio block data payload demands of data blocks to accommodate diagonal interleaving of preceding data blocks.

### FIELD OF THE INVENTION

The present invention relates to a communication system.

### BACKGROUND TO THE INVENTION

The concept of transport channels is known from UTRAN (Universal mobile Telecommunications System Radio Access Network). Each of these transport channels can carry a bit class having a different quality of service (QoS) requirement. A plurality of transport channels can be multiplexed and sent in the same physical channel.

### SUMMARY OF THE INVENTION

It is an object of the present invention to provide a system in which heterogeneous interleaving can be employed.

According to the present invention, there is provided method of transmitting a radio signal comprising a sequence of data blocks in a sequence of radio blocks having equal-sized data payloads, the method comprising:

transmitting an initial part of a first data block, having associated therewith a first physical transport time greater than the radio block interval, in a first radio block so as to fully occupy the data payload of the first radio block; and

transmitting a terminal part of a first data block and at least part of a second data block, having associated therewith a second physical transport time equal to the radio block interval, in a second radio block so as to fully occupy the data payload of the second radio block,

wherein said initial and terminal parts comprise equal proportions of the first data block.

The second radio block may carry all of said second data block.

An intermediate part of the first data block and part of the second data block, or at least part of the third data block, may be transmitted in a third radio block between the first and second radio blocks.

A method according to the present invention preferably includes performing a rate matching process on said data blocks for adapting them to the radio block data payload space available therefore.

According to the present invention, there is also provided a corresponding transmitter apparatus.

### BRIEF DESCRIPTION OF THE DRAWINGS

FIG. 1 shows a mobile communication system according to the present invention;

FIG. 2 is a block diagram of a mobile station;

FIG. 3 is a block diagram of a base transceiver station;

FIG. 4 illustrates the frame structure used in an embodiment of the present invention;

FIG. 5 illustrates a packet data channel in an embodiment of the present invention;

FIG. 6 illustrates the sharing of a radio channel between two half-rate packet channels in an embodiment of the present invention;

FIG. 7 illustrates the lower levels of a protocol stack used in an embodiment of the present invention;

FIG. 8 illustrates the generation of a radio signal by a first embodiment of the present invention;

FIG. 9 illustrates a signal employing heterogeneous interleaving;

FIG. 10 illustrates a data burst generated by a first embodiment of the present invention; and

FIG. 11 is a flowchart illustrating a method of receiving a signal as illustrated in FIG. 9.

### DETAILED DESCRIPTION OF THE PREFERRED EMBODIMENT

A preferred embodiment of the present invention will now be described, by way of example, with reference to the accompanying drawings.

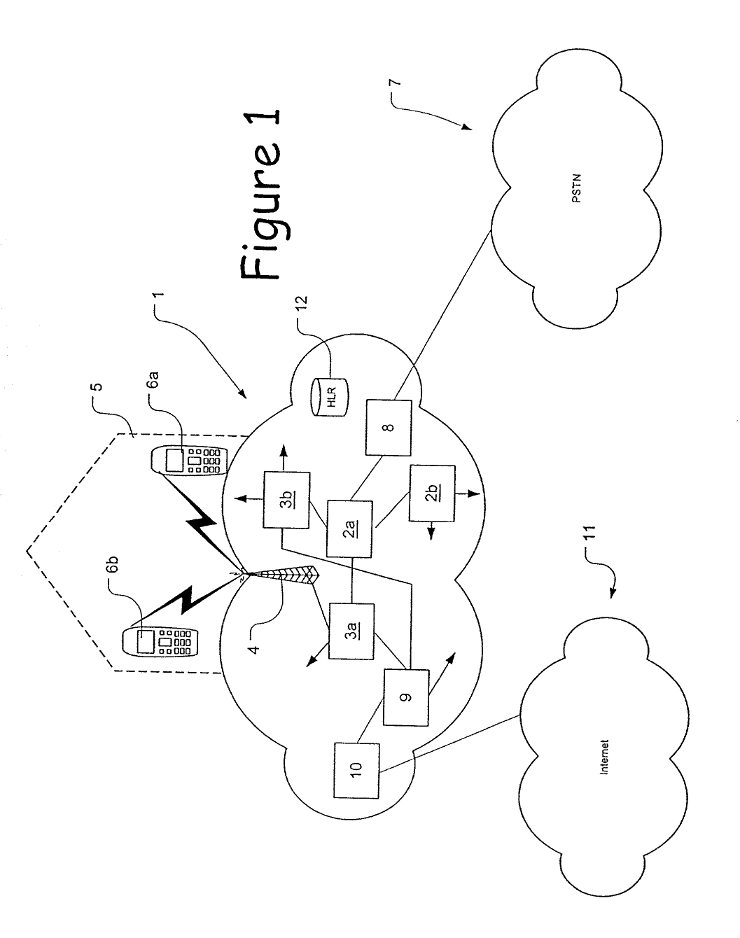

Referring to FIG. 1, a mobile phone network 1 comprises a plurality of switching centres including first and second switching centres 2a, 2b. The first switching centre 2a is connected to a plurality of base station controllers including first and second base station controllers 3a, 3b. The second switching centre 2b is similarly connected to a plurality of base station controllers (not shown).

The first base station controller 3a is connected to and controls a base transceiver station 4 and a plurality of other base transceiver stations. The second base station controller 3b is similarly connected to and controls a plurality of base transceiver stations (not shown).

In the present example, each base transceiver station services a respective cell. Thus, the base transceiver station 4 services a cell 5. However, a plurality of cells may be serviced by one base transceiver station by means of directional antennas. A plurality of mobile stations 6a, 6b are located in the cell 5. It will be appreciated what the number and identities of mobile stations in any given cell will vary with time.

The mobile phone network 1 is connected to a public switched telephone network 7 by a gateway switching centre 8.

A packet service aspect of the network includes a plurality of packet service support nodes (one shown) 9 which are connected to respective pluralities of base station controllers 3a, 3b. At least one packet service support gateway node 10 connects the or each packet service support node 10 to the Internet 11.

The switching centres 3a, 3b and the packet service support nodes 9 have access to a home location register 12.

Communication between the mobile stations 6a, 6b and the base transceiver station 4 employs a time-division multiple access (TDMA) scheme.

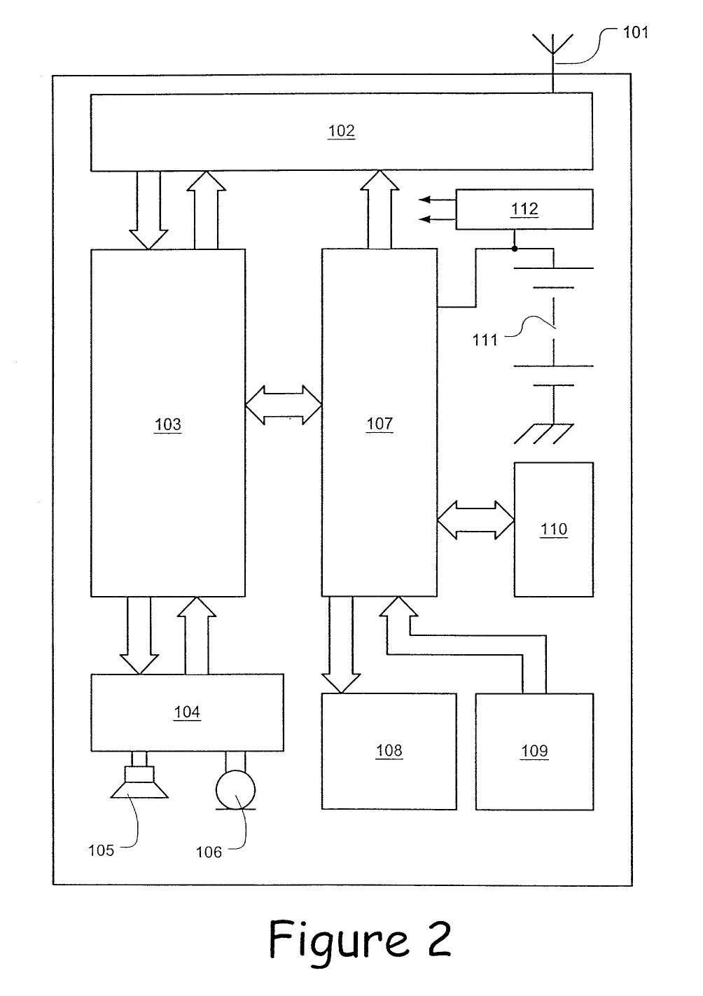

Referring to FIG. 2, the first mobile station 6a comprises an antenna 101, an rf subsystem 102, a baseband DSP (digital signal processing) subsystem 103, an analogue audio subsystem 104, a loudspeaker 105, a microphone 106, a controller 107, a liquid crystal display 108, a keypad 109, memory 110, a battery 111 and a power supply circuit 112.

The rf subsystem 102 contains if and rf circuits of the mobile telephone's transmitter and receiver and a frequency synthesizer for tuning the mobile station's transmitter and receiver. The antenna 101 is coupled to the rf subsystem 102 for the reception and transmission of radio waves.

The baseband DSP subsystem 103 is coupled to the rf subsystem 102 to receive baseband signals therefrom and for sending baseband modulation signals thereto. The baseband DSP subsystems 103 includes codec functions which are well-known in the art.

The analogue audio subsystem 104 is coupled to the baseband DSP subsystem 103 and receives demodulated audio therefrom. The analogue audio subsystem 104 amplifies the demodulated audio and applies it to the loudspeaker 105. Acoustic signals, detected by the microphone 106, are pre-amplified by the analogue audio subsystem 104 and sent to the baseband DSP subsystem 4 for coding.

The controller 107 controls the operation of the mobile telephone. It is coupled to the rf subsystem 102 for supplying tuning instructions to the frequency synthesizer and to the baseband DSP subsystem 103 for supplying control data and management data for transmission. The controller 107 operates according to a program stored in the memory 110. The memory 110 is shown separately from the controller 107. However, it may be integrated with the controller 107.

The display device 108 is connected to the controller 107 for receiving control data and the keypad 109 is connected to the controller 107 for supplying user input data signals thereto.

The battery 111 is connected to the power supply circuit 112 which provides regulated power at the various voltages used by the components of the mobile telephone.

The controller 107 is programmed to control the mobile station for speech and data communication and with application programs, e.g. a WAP browser, which make use of the mobile station's data communication capabilities.

The second mobile station 6b is similarly configured.

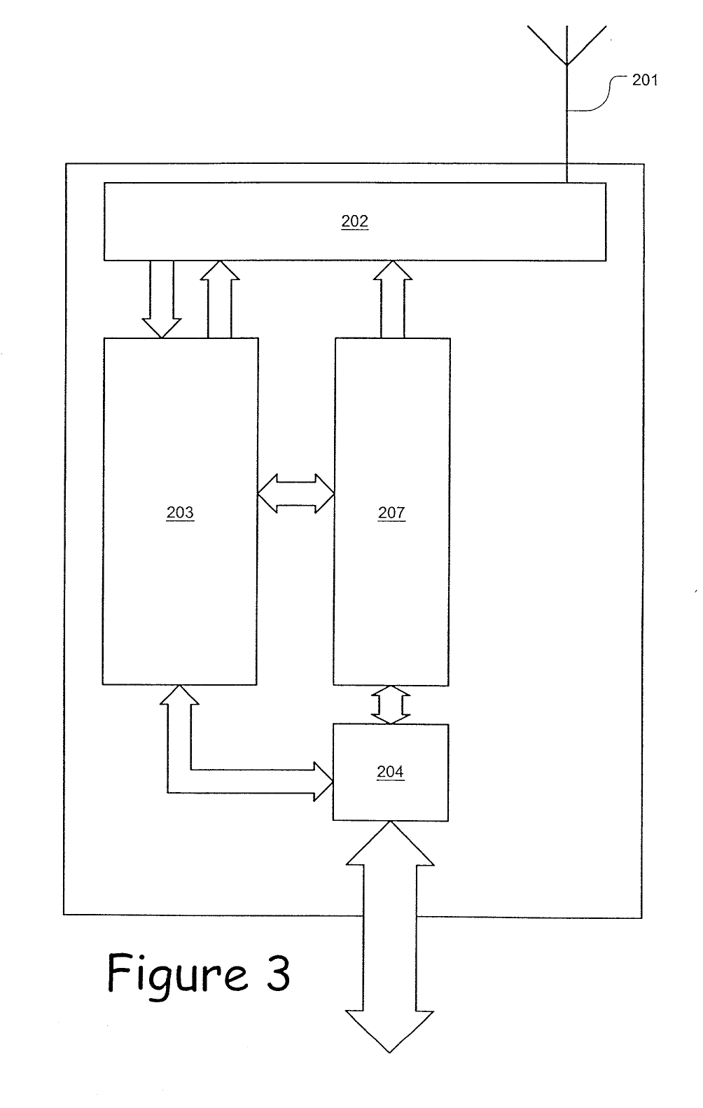

Referring to FIG. 3, greatly simplified, the base transceiver station 4 comprises an antenna 201, an rf subsystem 202, a baseband DSP (digital signal processing) subsystem 203, a base station controller interface 204 and a controller 207.

The rf subsystem 202 contains the if and rf circuits of the base transceiver station's transmitter and receiver and a frequency synthesizer for tuning the base transceiver station's transmitter and receiver. The antenna 201 is coupled to the rf subsystem 202 for the reception and transmission of radio waves.

The baseband DSP subsystem 203 is coupled to the rf subsystem 202 to receive baseband signals therefrom and for sending baseband modulation signals thereto. The baseband DSP subsystems 203 includes codec functions which are well-known in the art.

The base station controller interface 204 interfaces the base transceiver station 4 to its controlling base station controller 3a.

The controller 207 controls the operation of the base transceiver station 4. It is coupled to the rf subsystem 202 for supplying tuning instructions to the frequency synthesizer and to the baseband DSP subsystem for supplying control data and management data for transmission. The controller 207 operates according to a program stored in the memory 210.

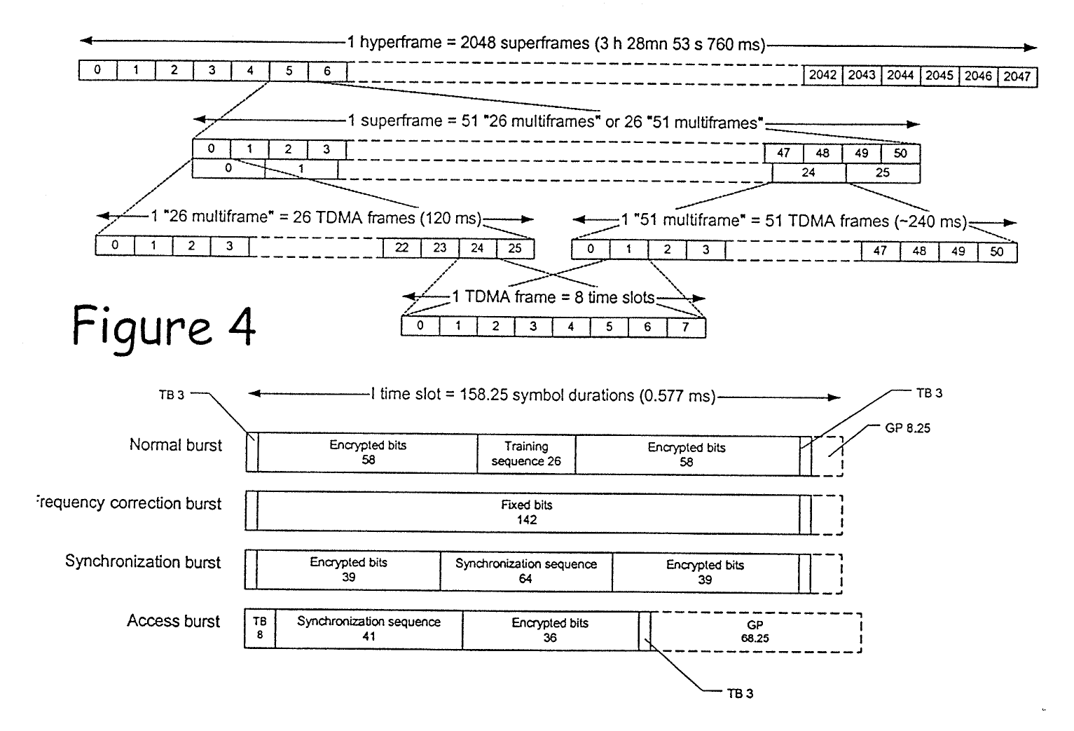

Referring to FIG. 4, each TDMA frame, used for communication between the mobile stations 6a, 6b and the base transceiver stations 4, comprises eight 0.577 ms time slots. A “26 multiframe” comprises 26 frames and a “51 multiframe” comprises 51 frames. Fifty one “26 multiframes” or twenty six “51 multiframes” make up one superframe. Finally, a hyperframe comprises 2048 superframes.

The data format within the time slots varies according to the function of a time slot. A normal burst, i.e. time slot, comprises three tail bits, followed by 58 encrypted data bits, a 26-bit training sequence, another sequence of 58 encrypted data bits and a further three tail bits. A guard period of eight and a quarter bit durations is provided at the end of the burst. A frequency correction burst has the same tail bits and guard period. However, its payload comprises a fixed 142 bit sequence. A synchronization burst is similar to the normal burst except that the encrypted data is reduced to two clocks of 39 bits and the training sequence is replaced by a 64-bit synchronization sequence. Finally, an access burst comprises eight initial tail bits, followed by a 41-bit synchronization sequence, 36 bits of encrypted data and three more tail bits. In this case, the guard period is 68.25 bits long.

When used for circuit-switched speech traffic, the channelisation scheme is as employed in GSM.

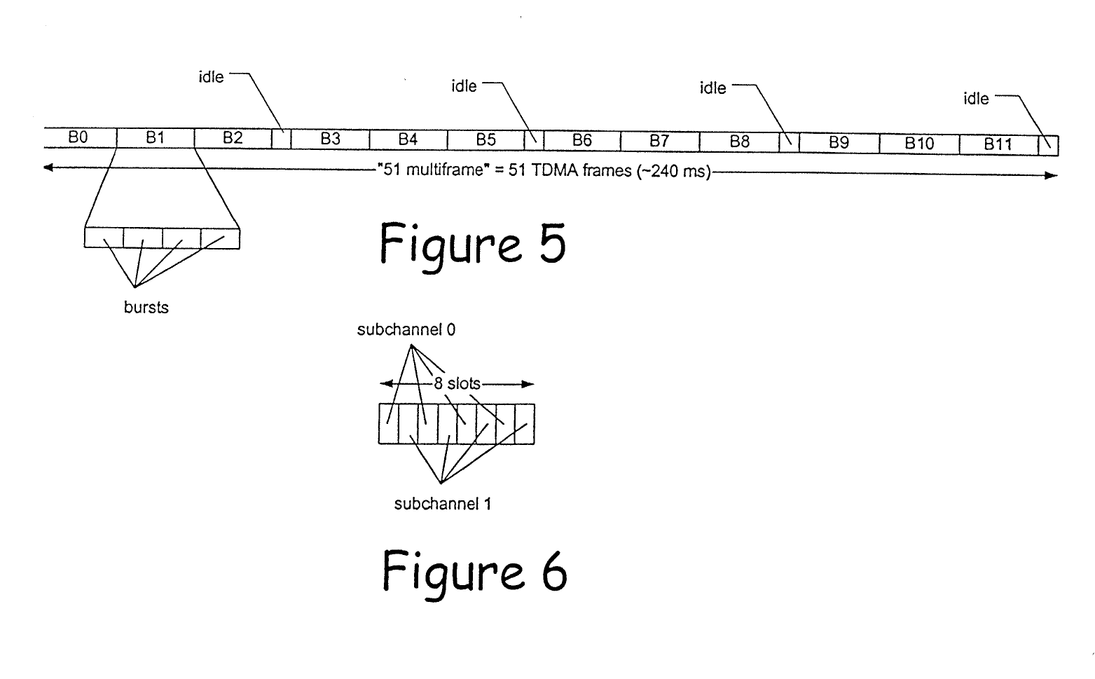

Referring to FIG. 5, full rate packet switched channels make use of 12 4-slot radio blocks spread over a “52 multiframe”. Idle slots follow the third, sixth, ninth and twelfth radio blocks.

Referring to FIG. 6, for half rate, packet switched channels, both dedicated and shared, slots are allocated alternately to two sub-channels.

The baseband DSP subsystems 103, 203 and controllers 107, 207 of the mobile stations 6a, 6b and the base transceiver stations 4 are configured to implement two protocol stacks. The first protocol stack is for circuit switched traffic and is substantially the same as employed in conventional GSM systems. The second protocol stack is for packet switched traffic.

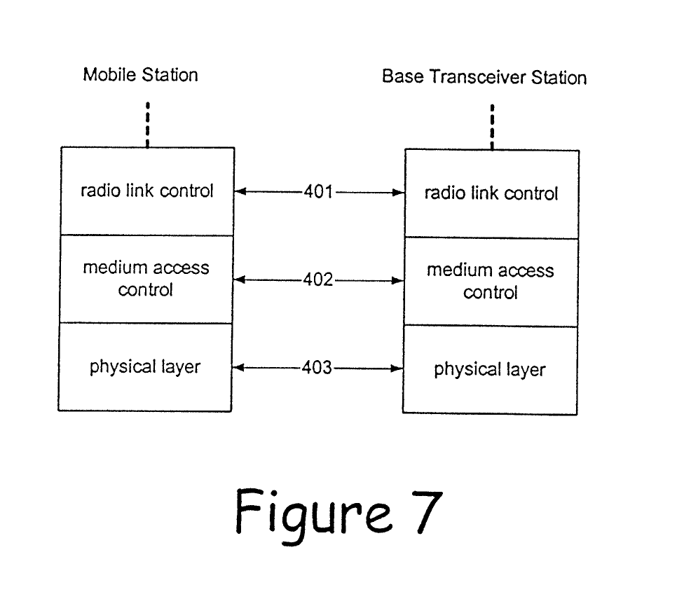

Referring to FIG. 7, the layers relevant to the radio link between a mobile station 6a, 6b and a base station controller 4 are the radio link control layer 401, the medium access control layer 402 and the physical layer 403.

The radio link control layer 401 has two modes: transparent and non-transparent. In transparent mode, data is merely passed up or down through the radio link control layer without modification.

In non-transparent mode, the radio link control layer 401 provides link adaptation and constructs data blocks from data units received from higher levels by segmenting or concatenating the data units as necessary and performs the reciprocal process for data being passed up the stack. It is also responsible for detecting lost data blocks or reordering data block for upward transfer of their contents, depending on whether acknowledged mode is being used. This layer may also provide backward error correction in acknowledged mode.

The medium access control layer 402 is responsible for allocating data blocks from the radio link control layer 401 to appropriate transport channels and passing received radio blocks from transport channels to the radio link control layer 403.

The physical layer 403 is responsible to creating transmitted radio signals from the data passing through the transport channels and passing received data up through the correct transport channel to the medium access control layer 402.

Transport blocks are exchanged between the medium access control layer 402 and the physical layer 403 in synchronism with the radio block timing, i.e. a transport block passed to the physical layer each radio block interval.

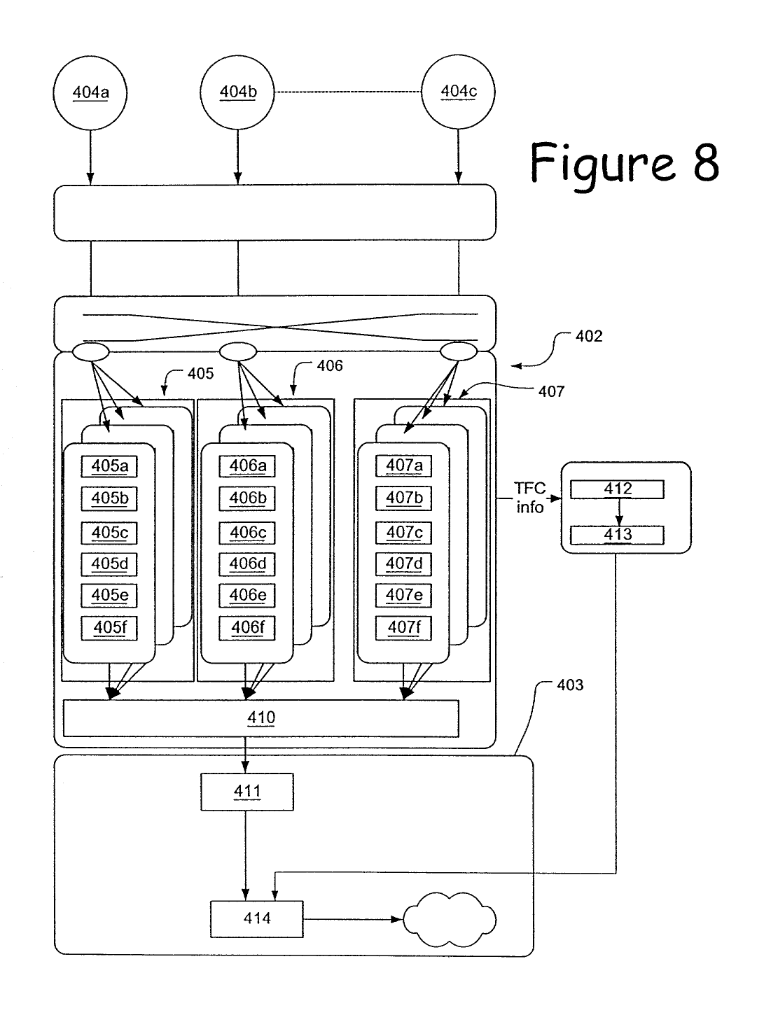

Referring to FIG. 8, data produced by applications 404a, 404b, 404c propagates down the protocol stack to the medium access control layer 402. The data from the applications 404a, 404b, 404c can belong to any of a plurality of classes for which different qualities of service are required. Data belonging to a plurality of classes may be produced by a single application. The medium access control layer 402 directs data from the applications 404a, 404b, 404c to different transport channels 405, 406, 407 according to class to which it belongs.

Each transport channel 405, 406, 407 can be configured to process signals according to a plurality of processing schemes 405a, 405b, 405c, 406a, 406b, 406c, 407a, 407b, 407c. The configuration of the transport channels 405, 406, 407 is established during call setup on the basis of the capabilities of the mobile station 6a, 6b and the network and the nature of the application or applications 404a, 404b, 404c being run.

The processing schemes 405a, 405b, 405c, 406a, 406b, 406c, 407a, 407b, 407c are unique combinations of cyclic redundancy check 405a, 406a, 407a, channel coding 405b, 406b, 407b, radio frame equalizing 405c, 406c, 407c, interleaving 405d, 406d, 407d, segmentation 405e, 406e, 407e and rate matching 405f, 406f, 407f. These unique processing schemes will be referred to as “transport formats” and transport blocks processed according to a transport format will be referred to as coded transport blocks. The different interleaving schemes can have different physical transport times (PTTs) associated with them.

Error detection is provided in each transport block through a CRC 405a, 406a, 407a. The size of the CRC to be used is fixed on each transport channel and configured by the radio link control layer. The entire transport block is used to calculate the CRC parity bits. The following CRC sizes could be used in order to fulfil the residual BER QoS requirements Error! Reference source not found.:

0 (no error detection)

6 (for AMR mainly)

12 (as in GPRS)

24 (as in UTRAN)

The channel coding 405b, 406b, 407b to be used is chosen by the radio link control layer and can only be changed through higher layer signalling and can be considered to be fixed for each transport channel. This means that for AMR, the same mother code is used for all the modes, and rate matching adjusts the code rate by puncturing or repetition.

Radio frame size equalisation 405c, 406c, 407c comprises padding the input bit sequence in order to ensure that the coded transport block can be segmented in an integer number of data segments of the same size. It is only used when the transmission time interval is longer than 20 ms (radio block duration).

In practice, radio frame size equalisation 405c, 406c, 407c just adds a few dummy bits at the end of the coded transport block whenever needed. Taking for instance a coded transport block 1234567 and a transmission time interval of 80 ms, one dummy bit is added at the end of the transport block in order to ensure that it can be divided in 4 segments (4 radio blocks of 20 ms): 12345678.

The first interleaver 405d, 406d, 407d is a simple block interleaver with inter-column permutation. It is used when the transmission time interval is greater than the size of the radio block (transmission time interval>radio block duration) and is transparent otherwise. Its task is to ensure that no consecutive coded bits are transmitted in the same radio block.

When the transmission time interval is longer than 20 ms, the input bit sequence is segmented and mapped onto n consecutive radio blocks (n=(transmission time interval)/20). Following radio frame size equalisation the input bit sequence length is guaranteed to be an integer multiple of n.

The rate matching means that bits on a transport channel are repeated or punctured. Higher layers assign a rate-matching attribute for each transport channel. This attribute is semi-static and can only be changed through higher layer signalling. The rate-matching attribute is used when the number of bits to be repeated or punctured is calculated, the higher the attribute the more important the bits (more repetition/less puncturing). Rate-matching attributes are only significant when compared between each other. For instance if the rate-matching attribute of a first tranport channel is 2 and the rate-matching attribute of a second transport channel is 1, the first transport channel is twice as important as the second transport channel.

Since the block size is a dynamic attribute, the number of bits on a transport channel can vary between different transmission time intervals. When it happens, bits are repeated or punctured to ensure that the total bit rate after transport channel multiplexing is identical to the total channel bit rate of the allocated dedicated physical channels. Outputs from the rate matching are called radio frames. Every 20 ms the rate matching produces one radio frame for every transport channel.

The rate matching adjusts the size of the transport blocks to fit the radio block based on rate matching attributes (the higher the attribute, the more important the bits are). For instance, if two transport blocks with the same rate matching attribute are to be sent within the same radio block, they will use half of the available payload.

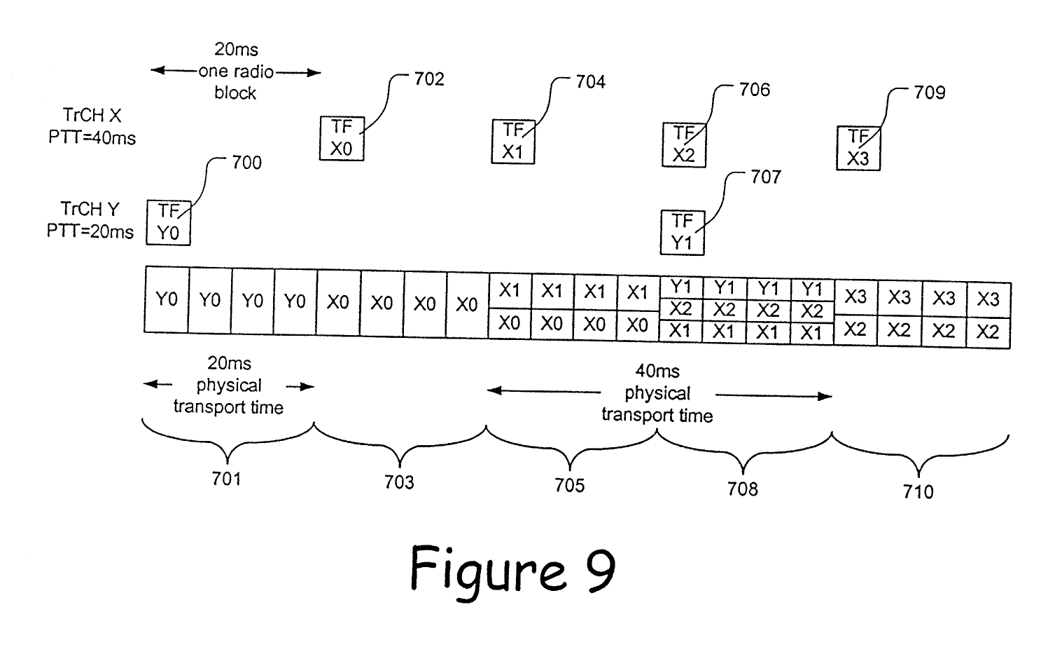

Referring to FIG. 9, a first transport block 700, belonging to a first transport channel TrCH Y, has a first transport format TFY0 and is consequently subject to a simple interleaving scheme which interleaves all of the bits of the first transport block within a first radio block 701 and has a physical transport time of 20 ms. The rate matching ensures that the first radio block 701 is fully occupied by the first transport block 700.

A second transport block 702, belonging to a second transport channel TrCH X, has a second transport format TFX0 and subject to a diagonal interleaving scheme with a physical transport time of 40 ms. The rate matching ensures however that a second radio block 703 is fully occupied by half of the data of the second transport block 702.

A third transport block 704, belonging to a second transport channel TrCH X, has a third transport format TFX1 and is subject to a diagonal interleaving scheme with a physical transport time of 40 ms. A third radio block 705 is split 50:50, by means of the rate matching, between the second half of the second transport block 702 and the first half of the third transport block 704.

Fourth and fifth transport blocks 706, 707, belonging respectively to the second and first transport channels TrCH X, TrCH Y, are passed from the medium access control layer 402 at substantially the same time. The fourth transport block has a physical transport time of 40 ms, i.e. is subject to a diagonal interleaving scheme, and format TFX2 and the fifth transport block has a physical transport time of 20 ms and format TFY1. The rate matching operates to divide up a fourth radio block 708 equally between the second half of the third transport block 704, the first half of the fourth transport block 706 and all of the fifth transport block 707.

A sixth transport block 709, belonging to a second transport channel TrCH X, has a third transport format TFX3 and is subject to a diagonal interleaving scheme with a physical transport time of 40 ms. A fifth radio block 710 is split 50:50, by means of the rate matching, between the second half of the fourth transport block 702 and the first half of the sixth transport block 709.

It can be seen that when a transport block has a transport format with a physical transfer time greater than the radio block interval, the rate matching for following transport blocks is modified to reduce their radio block capacity requirements until the whole of the long physical transport time transport block has been transmitted. If the physical transport time is twice the radio block interval, then the radio block capacity requirement of the succeeding transport block is halved and, if the physical transport time is three time the radio block interval, then the radio block capacity requirement of each of the two succeeding transport blocks is reduced by one third, and so on.

The combined data rate produced for the transport channels 405, 406, 407 must not exceed that of physical channel or channels allocated to the mobile station 6a, 6b. This places a limit on the transport format combinations that can be permitted. For instance, if there are three transport formats TF1, TF2, TF3 for each transport channel, the following combinations might be valid:—

TF1 TF1 TF2

TF1 TF3 TF3

but not

TF1 TF2 TF2

TF1 TF1 TF3

The data output by the transport channel interleaving processes are multiplexed by a multiplexing process 410 and then subject to further interleaving 411.

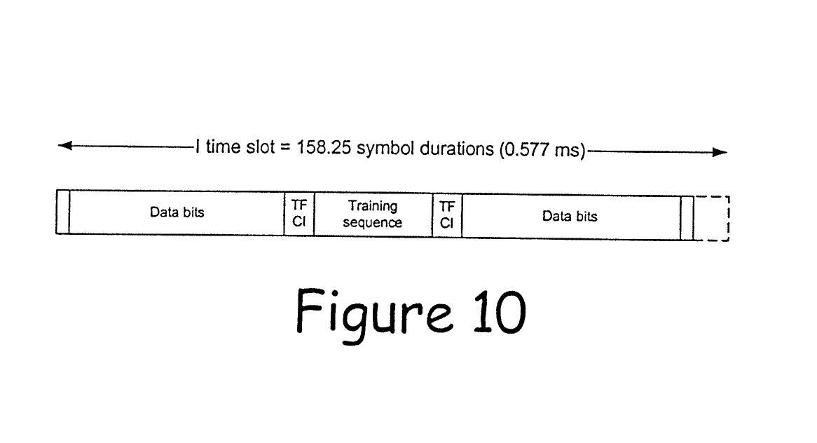

A transport format combination indicator is generated by a transport format combination indicator generating process 412 from information from the medium access control layer and coded by a coding process 413. The transport format combination indicator is inserted into the data stream by a transport format combination indicator insertion process after the further interleaving 411. The transport format combination indicator is spread across one radio block with portions placed in fixed positions in each burst, on either side of the training symbols (FIG. 10) in this example. The complete transport format combination indicator therefore occurs at fixed intervals, i.e. the block length 20 ms. This makes it possible to ensure transport format combination indicator detection when different interleaving types are used e.g. 8 burst diagonal and 4 burst rectangular interleaving. Since the transport format combination indicator is not subject to variable interleaving, it can be readily located by the receiving station and used to control processing of the received data.

The reception of a signal as illustrated in FIG. 9 at a receiving station will now be described.

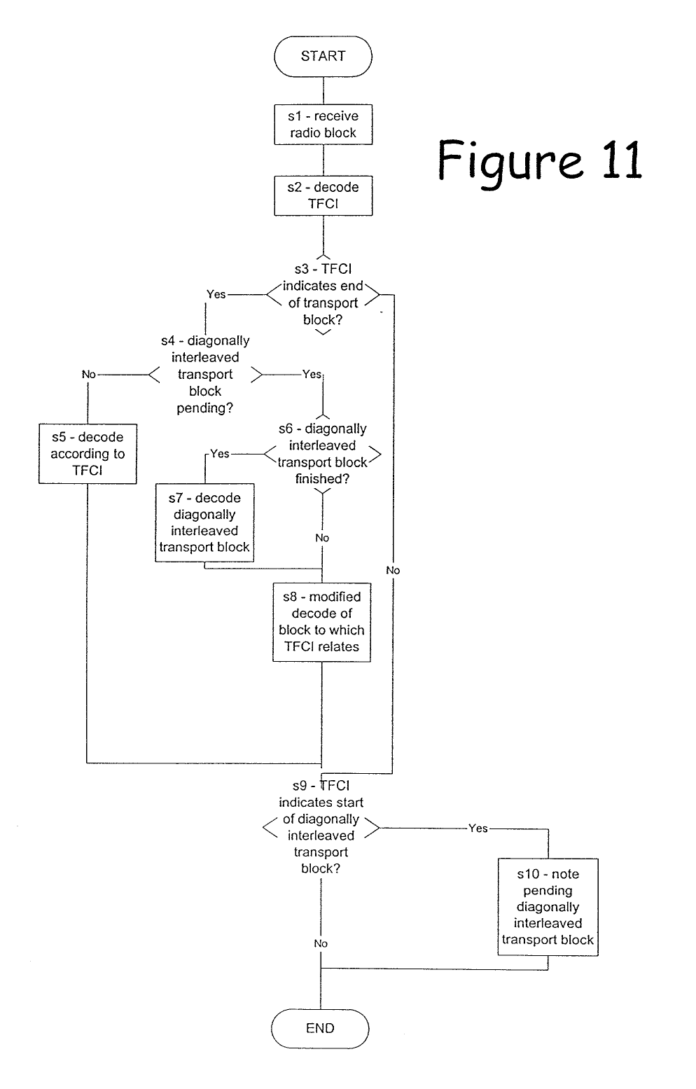

Referring to FIG. 11, at a receiving station, when a radio block is received (step s1), it transport format combination indicator is decoded (step s2). If the transport format combination indicator indicates that a transport block ends in the radio block (step s3), it is determined whether a transport block having a physical transport time greater than the radio block interval is pending (step s4). If no transport block having a physical transport time greater than the radio block interval is pending, the transport block received in the radio block is decoded according to the associated transport format combination indicator (step s5).

If, at step s4, transport block having a physical transport time greater than the radio block interval is pending, it is determined whether a transport block having a physical transport time greater than the radio block interval is completed in the current radio block (step s6) and, if so, it is decoded (step s7). Whatever the result at step s6, the transfer block to which the transport format combination indicator relates is decoded using a modified process taking into account its reduced size (step s8).

If, at step s3, it is determined that no transport blocks are being completed and following steps s5 and s8, it is determined whether a transport block having a physical transport time greater than the radio block interval is starting (step s9) and, if so, this and the physical transport time value are noted (step s10) for use in steps s4 and s6.

The location of data for each transport channel within the multiplexed bit stream can be determined by a received station from the transport format combination indicator and knowledge of the multiplexing process which is deterministic.

It will be appreciated that the above-described embodiments may be modified in many ways without departing from the spirit and scope of the claims appended hereto.

What is claimed is:

1. A method of transmitting a radio signal comprising a sequence of data blocks in a sequence of radio blocks having equal-sized data payloads, the method comprising:—
transmitting an initial part of a first data block, having associated therewith a first physical transport time greater than the radio block interval, in a first radio block so as to fully occupy the data payload of the first radio block; and
transmitting a terminal part of a first data block and at least part of a second data block, having associated therewith a second physical transport time equal to the radio block interval, in a second radio block so as to fully occupy the data payload of the second radio block,
wherein said initial and terminal parts comprise equal proportions of the first data block.

2. A method according to claim 1, wherein the second radio block carries all of said second data block.

3. A method according to claim 1, comprising transmitting a intermediate part of the first data block and part of said second data block in a third radio block between the first and second radio blocks.

4. A method according to claim 1, comprising transmitting a intermediate part of the first data block and all of a third data block in a third radio block between the first and second radio blocks.

5. A method according to claim 4, wherein the second radio block carries all of said second data block.

6. A method according to claim 1, including performing a rate matching process on said data blocks for adapting them to the radio block data payload space available therefore.

7. A radio transmitter for transmitting a radio signal comprising a sequence of data blocks in a sequence of radio blocks having equal-sized data payloads, the transmitter comprising means for:—
(a) transmitting an initial part of a first data block, having associated therewith a first physical transport time greater than the radio block interval, in a first radio block so as to fully occupy the data payload of the first radio block; and
(b) transmitting a terminal part of a first data block and at least part of a second data block, having associated therewith a second physical transport time equal to the radio block interval, in a second radio block so as to fully occupy the data payload of the second radio block,
wherein said initial and terminal parts comprise equal proportions of the first data block.

8. A transmitter according to claim 7, wherein the second radio block carries all of said second data block.

9. A transmitter according to claim 8, comprising means for transmitting a intermediate part of the first data block and part of said second data block in a third radio block between the first and second radio blocks.

10. A transmitter according to claim 7, comprising means for transmitting a intermediate part of the first data block and all of a third data block in a third radio block between the first and second radio blocks.

11. A transmitter according to claim 10, wherein the second radio block carries all of said second data block.

12. A transmitter according to claim 7, including performing a rate matching process on said data blocks for adapting them to the radio block data payload space available therefore.
